(19) United States
(12) Patent Application Publication
(10) Pub. No.: US 2020/0318276 A1
(43) Pub. Date: Oct. 8, 2020

(54) ARTICLES AND DESIGNS WITH NEEDLEPOINT AND OTHER INTERCHANGEABLE INSERT ELEMENTS

(71) Applicant: Stephanie Booth, Pooler, GA (US)

(72) Inventor: Stephanie Booth, Pooler, GA (US)

(21) Appl. No.: 16/837,826

(22) Filed: Apr. 1, 2020

Related U.S. Application Data
(60) Provisional application No. 62/828,234, filed on Apr. 2, 2019.

(51) Int. Cl. D05C 17/00; A47G 33/08

(52) U.S. Cl. CPC D05C 17/00; A47G 33/08

(57) ABSTRACT

This invention expands and improves upon the existing art by providing numerous new vehicles whereby decorative inserts are received on or in different surfaces to enhance visual effects. Embodiments of the invention specify one or more regions associated with an article wherein a decorative insert may be interchanged. The region may be a cavity to receive the insert, after which the cavity may be protected with a transparent or translucent cover that may involve a frictional fit, form part of a hinged door, and so forth. Alternatively, if the insert is a fabric or textile containing embroidery, needlepoint of the like, the region may comprise an area with a perimeter conducive to sewing or stitching. Again, the region may or not be protected with a cover of some kind. Specific embodiments include see-through bowls that accept flexible, elongated inserts for side viewing, and wreath holders with multiple degrees of interchangeability.

### REFERENCE TO RELATED APPLICATIONS

This Application claims priority to, and the benefit of, U.S. Provisional Patent Application Ser. No. 62/828,234, filed Apr. 2, 2019, the entire content of which is incorporated herein by reference.

### BACKGROUND OF THE INVENTION

There are now a few products that include inserts for design elements such as needlepoint and photographs, but the variety is very limited. For example, there are Christmas ornaments that accept needlepoint, and there are frames that receive interchangeable photos, but many other possible configurations have not yet been considered.

### SUMMARY OF THE INVENTION

This invention recognizes the lack of articles and products able to receive decorative inserts by providing various reconfigurable articles in accordance with different embodiments.

One such embodiment assumes the form of a bowl comprising a shell component, a flexible insert, and an insert retainer component. The shell component includes an upper rim, an outer wall extending downwardly and outwardly from the upper rim and an inner wall extending downwardly and inwardly to a bottom wall forming a bowl structure. At least a portion of the outer wall is transparent or translucent, and the outer and inner walls are spaced apart, forming a cavity between the outer and inner walls that is accessible from the bottom of the shell component. The flexible insert has at least one side surface that includes graphical or textual visual indicia. The flexible insert is configured for insertion into the bottom of the cavity so as to occupy the cavity of the shell enabling a user to visualize the graphical or textual indicia through the transparent or translucent outer wall of the shell. The retainer component maintains the flexible insert in position in the cavity of the shell.

The upper rim of the shell may be circular with a diameter, and the lower rim of the shell may be circular as well with a diameter larger than that of the upper rim. The upper rim may in the range of 4 to 8 inches.

The flexible insert may comprise a thin strip of flexible material having a concave upper edge and a convex lower edge defining a width, and two ends defining a length. The outer wall of the shell defines a height, and the width of the flexible insert preferably corresponds to the height of the outer wall of the shell.

The retainer component may be configured for insertion into the cavity of the shell such that the flexible insert is disposed between the retainer component and the outer wall of the shell. The retainer component includes an upper edge and a lower edge, and the lower edge of the retainer component may temporarily and releasably engage with the shell proximate to the lower rim of the shell. For example, the outer wall of the shell may include an inner annular groove proximate to the lower rim of the shell, and the lower edge of the retainer component may include one or more protrusions or tabs that engage with the inner annular groove of the outer wall of the shell.

In the preferred embodiment, the retainer component forms a frusto-conical shape. Optionally, the bottom wall of the sealed bowl structure may include a region adapted to receive a second insert including graphical or textual visual indicia. In one such embodiment, the bottom wall of the sealed bowl structure is transparent or translucent, and he region adapted to receive the second insert may comprise a cavity accessible from the bottom of the shell component. A cover may be provided for closing off the cavity with the second insert retained therein such that the graphical or textual indicia of the second insert is visible through the bottom wall of the sealed bowl structure from above.

A reconfigurable article according to the invention may include an elongated member having first and second ends, and wherein the first end of the elongated member is bent into a hanger shape. A body is provided having a front surface, a back surface and a peripheral edge defining a geometric shape. The geometric shape may be circle, oval, polygon, special shape such as a heart, clover, etc. or seasonal shape such as a Christmas tree, Easter egg, Star of David, skull for Halloween, and so forth. The front surface of the body may include a region configured to receive an insert having first and second opposing sides, and wherein at least one of the sides includes graphical or textual visual indicia. The back surface of the body includes a device that facilitates temporarily and releasable attachment to the second end of the elongated member. Such attachment may be magnetic or mechanical, including hook-and-loop fasteners.

The region configured to receive the insert may include a cavity and a cover that mounts over the cavity to protect the insert or, alternatively, the insert is sewn, stitched or otherwise bonded to the region with or without a cover.

In a specific embodiment, the first end of the elongated member is bent to conform to the upper edge of a door such that the elongated member hangs downwardly. The second end of the elongated member is bent upwardly to hold a toroidally shaped wreath, and the body temporarily and releasably attaches to the second end of the elongated member such that the graphical or textual visual indicia faces outwardly from the door.

A flexible insert configured for insertion into a cavity in a reconfigurable article comprises a thin flexible elongated substrate having front and back outer surfaces, a concave upper edge and a convex lower edge defining a width, and two ends defining a length. One or both of the front and back outer surfaces is adapted to receive graphical or textual visual indicia. The concave upper edge and convex lower edge may be circular curves with radii measured from a common center point, such that the width of the flexible insert is consistent along its length. The thin flexible elongated substrate may be a mesh material adapted to receive needlepoint or crocheted graphical or textual visual indicia.

### BRIEF DESCRIPTION OF THE DRAWINGS

FIG. 1A illustrates a way in which an interchangeable insert may be placed in a cavity behind a clear or translucent panel on an article and retained with a cap;

FIG. 1B shows how an interchangeable insert may be placed on the outer surface of an article and stitched into position directly, or covered with a protective panel;

FIG. 2A depicts a round bowl with needlepoint or other decorative feature on the bottom and/or side(s) of bowl, possibly using an assembly of the type shown in FIG. 1A to protect the artwork;

FIG. 2B shows a bowl in the shape of a cat's head according to the invention;

FIG. 2C shows a bowl in the shape of a dog's head according to the invention;

FIG. 2D illustrates a bone-shaped bowl;

FIG. 2E illustrates a different type of bone-shaped bowl;

FIG. 2F illustrates a further type of bone-shaped bowl;

FIG. 2G is a drawing that shows a bowl adapted to receive a flexible insert from the bottom;

FIG. 2H shows the way in which the bowl of FIG. 2G may be assembled;

FIG. 2I is a detail view illustrating the way in which a flexible insert is retained;

FIG. 2J is a drawing that shows a template configured for installation into the inner ring of a clear bowl including a decorative feature;

FIG. 2K illustrates a rounded rectangular bowl with a bottom insert similar to the arrangement of FIG. 1A;

FIG. 2L is a cross section of the embodiment illustrated in FIG. 2H;

FIG. 3 shows a magnetic holder for a wreath cover with an opening that accepts interchangeable features;

FIG. 4A depicts an over-the-door long wreath holder with an insert structure;

FIG. 4B is a drawing that shows a mechanical connection for a wreath holder insert body;

FIG. 4C is a drawing that shows a magnetic or hook-and-loop connection for a wreath holder insert body;

FIG. 5 illustrates a soap dish with different portions configured to receive interchangeable decorative elements;

FIG. 6A shows a round cake platter stand;

FIG. 6B shows a square platter;

FIG. 7 is a drawing of a wine-carrying case wherein a decorative element may be sewn on any outer surface thereof;

FIG. 8 illustrates a decorative insert on top of a cigar case holder;

FIG. 9 is drawing of a small desk humidor box in a closed and open configuration with a space adapted to receive a decorative element;

FIG. 10 shows a Martingale and Zweig art canvas collar for needlepoint inserted and sewn in middle leather on edges;

FIG. 11 illustrates a round ceramic photo planter pot with an opening for interchangeable elements;

FIG. 12 shows a DVD or compact disc sleeve;

FIG. 13 depicts a photo vase with one or more openings configured to receive interchangeable elements;

FIG. 14 is a scarf clip holders with a front opening that my assume any of the shapes disclosed herein;

FIG. 15 is a different scarf clip holder configuration;

FIG. 16 is rifle or shotgun case with outside pocket of needlepoint sewn on outside; and

FIG. 17 is a wrought iron double bowl holder including a central opening that may be configured to hold needlepoint or other decorative elements.

### DETAILED DESCRIPTION OF THE PREFERRED EMBODIMENTS

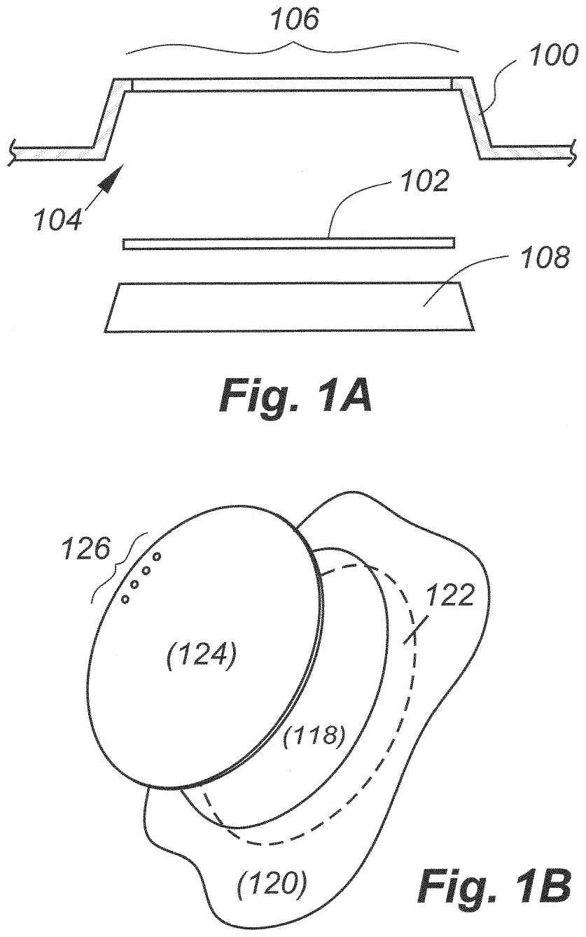

This invention improves upon, and extends, the possibilities for interchangeable graphical elements in a wide variety of articles and products that have so far been overlooked. A variety of alternative embodiments are disclosed herein, and in each case, the inclusion of the insert may be a function of product type. For example, with hard or rigid articles, the interchangeable insert 102 may be placed in a cavity 104 behind a clear or translucent panel on the article and retained with a cap 108, as shown in FIG. 1A. The cap 108 may be held in position with any suitable closure, including friction fit, threaded, bayonet, and so forth. Alternatively, for soft articles made of leather or other softer materials, the interchangeable insert 118 may be placed on the outer surface of the article 120 and stitched into position directly, or covered with a protective panel 124, as illustrated in FIG. 1B. The panel 124 may include peripheral holes 126 to facilitate stitching to the article 120.

The articles and embodiments disclosed here may be made of any suitable materials, including, without limitation:
1. Melamine
2. Lexan
3. Acrylic
4. Ceramic
5. Plastic
6. Porcelain
7. Glass
8. Leather for Cigar Cases
9. Polystyrene
10. Cast Iron
11. Polystyrene
12. Wrought Iron

Further, in each of the embodiments disclosed herein, possible insert placement is shown in broken-line form, with the understanding that virtually any insert shape may be used, including circular, oval, polygonal, square or rectangular with or without rounded corners, heart/spade/club/diamond-shaped, pet or fish-shaped, etc.

“Decorative element” may be taken to include any one or more of the following:
1. Paper
2. Photo
3. Aida Cloth for cross stitch, sizes 6,8,11,14,16,18 and 20 “count sizes”
4. Zweig art needlepoint canvas
5. Fabric, felt
6. Embroidery paper
7. All even weave cross-stitch and needlework fabric, needlepoint canvas
8. Cross stitch fabric
9. Hardanger fabric
10. Waste canvas and sublimated items
11. Plastic canvas
12. Herta cloth
13. Linen
14. Perforated Paper
15. Fiddlers Cloth
16. Pre-worked or pre-finished needlepoint or embroidery items
17. Penelope canvas
18. Machine embroidered or sublimated items
19. Screen printed items
20. Mono-needlepoint canvas
21. Hand painted artwork on finished insert on canvas

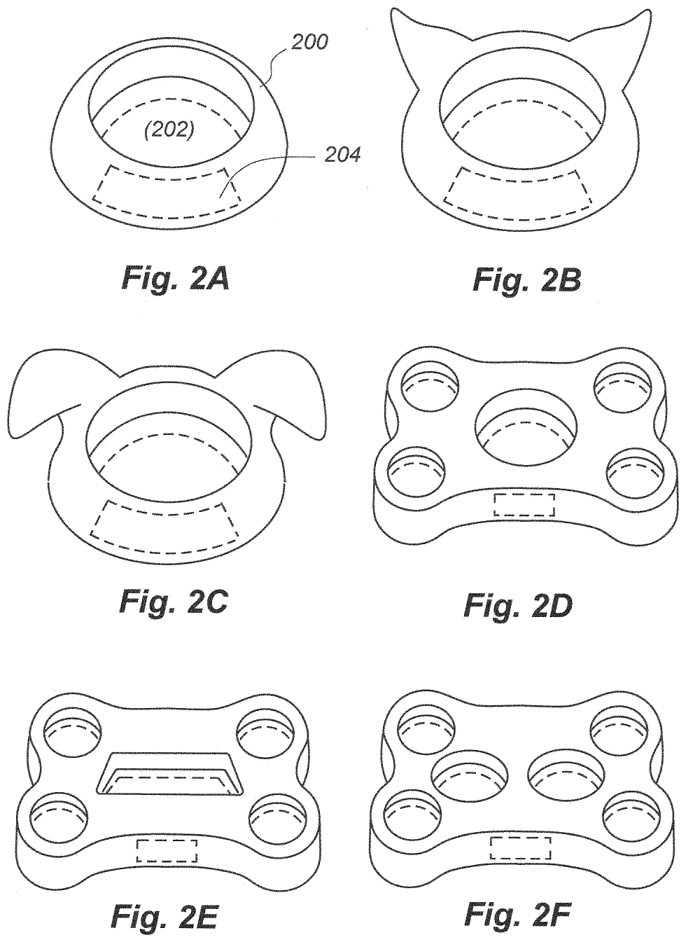

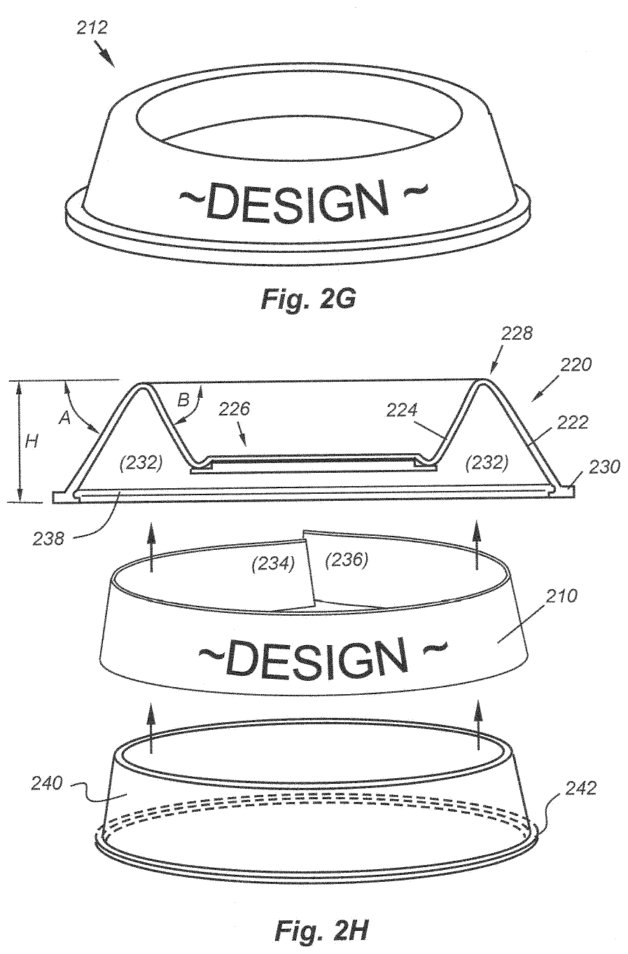

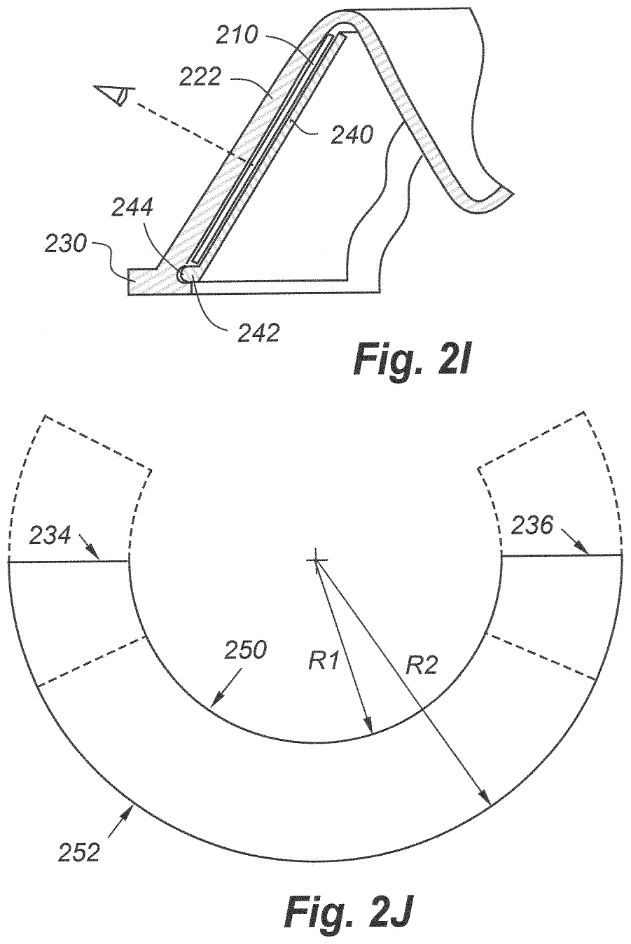

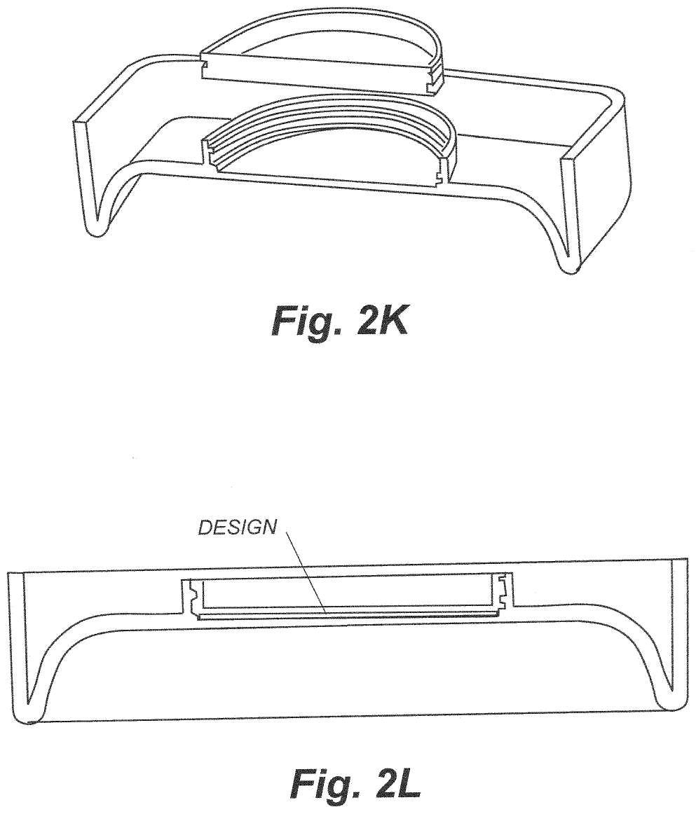

FIG. 2 is a drawing that shows various pet bowls applicable to the invention. In each case, the insert may be visible through the bottom of the bowl and/or through the side(s). FIG. 2A shows a round bowl 200, with needlepoint or decorative feature on the bottom 202 and/or side(s) of bowl, possibly using an assembly of the type shown in FIGS. 1A, 1B to protect the artwork. Although the area 204 depicts only a portion of the side of the bowl, the entire outside of the bowl may be used. FIG. 2B shows a cathead bowl, and FIG. 2C shows a dog head bowl. FIGS. 2D-2F illustrate bone-shaped bowls with single, double and oblong feeding depressions.

FIG. 2G is a drawing that shows a bowl 212 adapted to receive a flexible insert 210 from the bottom. FIG. 2H shows the way in which the bowl of FIG. 2G may be assembled. This embodiment of the invention includes an outer shell 220 having an outer wall 222 and an inner wall 224. At least wall 222 is at least partially transparent or translucent, through the entire shell 220 may be at least partially transparent or translucent. Wall 224 slopes down to a bottom surface 226 that may, optionally, include a decorative element holder of the type depicted in FIGS. 1A, 1B. In the preferred embodiment, wall 222 diverges outwardly from an upper rim 228 to a lower rim 230, and inner wall 224 diverges outwardly from the upper rim 228 to the bottom surface 226. In the preferred embodiments, the upper and lower rims are circular, and the article is adapted to receive pet food or water. However, the article may assume different shapes and may be adapted for different purposes. As one example, the upper and lower rims may be oval shaped, in which case the geometry of the insert 210 would have to be modified accordingly.

As opposed to a pet bowl, the article of FIGS. 2G-J may be configured as a bowl for cereal or other human consumables, a soap dish, or for other applications. Further, the angles A, B, may be varied from those shown, to provide a bowl with vertical or near-vertical walls, or with larger angles to achieve a more flattened shape. The height of the bowl may vary as well, preferably in the range of 1 to 5 inches, more preferably in the range of 2 to 4 inches, particularly for pet feeding applications. The upper rim, if circular, may be in the range of 4 to 12 inches, more preferably in the range of 5 to 8 inches, and the lower rim may be in the range of 4 to 12 inches, more preferably 5 to 8 inches, depending upon the size of the upper rim and the desired appearance.

Continuing the reference to FIG. 2H, a flexible insert 210 is manually curled and fitted into the space 232 between walls 222, 224. In preferred embodiments, the flexible insert 210 is curled into a frusto-conical shape prior to insertion. The ends 234, 236 may be attached with glue, tape or other adhesives, or the ends may simply be left to overlap. The insert 210 may include any type of design based upon any of the materials listed as “decorative elements” as defined herein. The same design may be on one or both sides of the insert material, or different designs may be used on opposing sides; that is, the insert may be reversible.

Once the insert is installed into space 232 of shell 220, it is held in position with a retainer 240, preferably with angled walls that correspond to the angle “A” of shell wall 222. The retainer 240 may be transparent, translucent, opaque, or of any color. Both the shell 220 and retainer are preferably constructed of molded plastic. With wall 222 being transparent or translucent, if portions of the design are transparent or translucent, portions of the retainer 240 may also be visible externally to a user. The bottom portion of retainer 240 may comprise an open ring or, alternatively, may have a closed bottom panel. Regardless, the bottom edge of retainer 240 preferably includes an outwardly protruding rim 242 that snaps into a corresponding recess in the shell 220. The shell 220 may be provided with a panel 238 that is removed to accept the retainer 240.

FIG. 2I is a detail drawing that illustrates the way in which flexible insert is retained. This figure illustrates the way in which an annular protruding rim 242 on retainer 240 snaps into a corresponding annual groove on the lower, inner surface of wall 222. Once retained, the design associated with flexible insert 210 is visible from outside the article. Different structures may be used to engage the retainer 240 with the shell. For example, at least the protruding ring 242 on retainer 240 may be discontinuous or interrupted to ease insertion and removal. If the retainer 240 has a closed bottom panel, finger holes may be provided on the panel to ease insertion and removal. While it is anticipated that the retainer 240 is removable and replaceable to change flexible insert 210, the retainer 240 may be cemented in position to prevent insert changing.

FIG. 2J is a drawing that shows a geometrical shape associated with flexible insert 210. The shape has a curved concave edge 250 spaced apart from a curved convex edge 252 by a distance “D.” For pet bowl applications, D is preferably in the range of 1 to 5 inches, more preferably 2 to 3 inches. Edges 250, 252 may be circular, and may have radii R1, R2 measured from a common center point “C.” Radii R1, R2 may be in the range of 4 to 12 inches or more, and ends 234, 236 may be longer or shorter as shown with the broken lines depending upon the degree of overlap used and/or desired side slope.

FIGS. 2K and L illustrate a rounded rectangular bowl with a bottom insert similar to the arrangement of FIG. 1A.

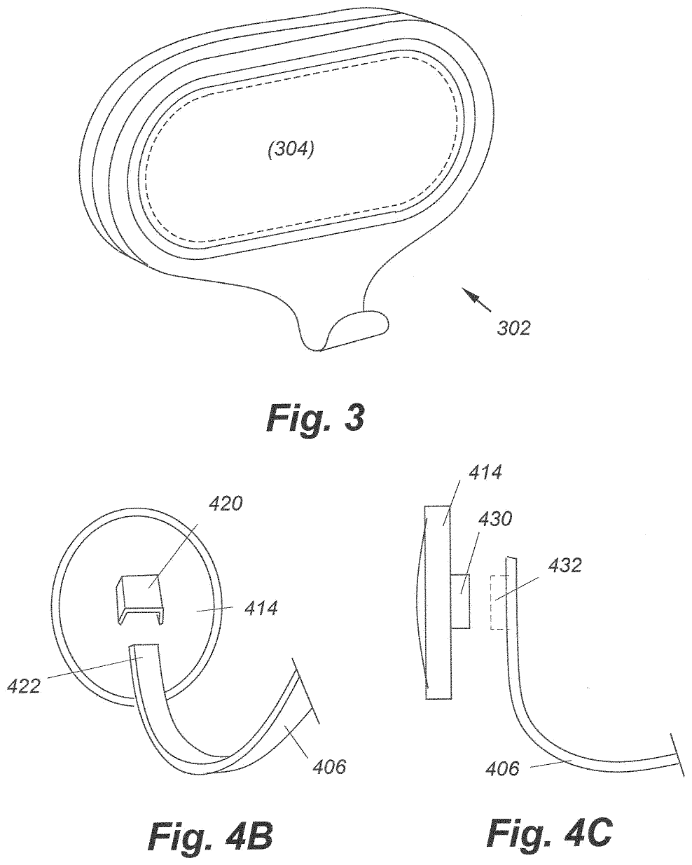

FIG. 3 shows a magnetic hanger embodiment according to the invention generally at 302. The article includes a body 303 including a lower hook, a magnetic back surface, and a region 304 used to receive a decorative insert. As with most other embodiments disclosed herein, region 304 may comprise a cavity to hold a photo, needlepoint or other substrate, and may be protected with a transparent cover. The cover may be press-fit, as described with reference to FIGS. 1A, 1B, or the cover may form part of a hinged door. Alternatively, a needlepoint, fabric or textile insert may be stitched into position as shown with broken line 312. The hanger may be attached to a refrigerator or other magnetic surface or, optionally, an additional hanger 308 may be disposed back-to-back relative to a non-magnetic panel such as glass pane 312.

The holder body and/or region 304 may include round, oval, square and various other shapes that accept interchangeable inserts.

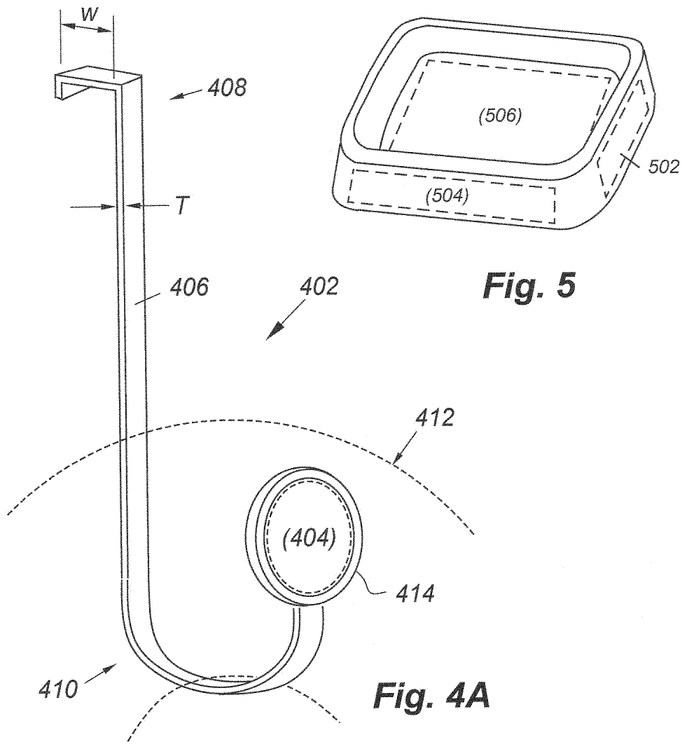

FIG. 4 depicts a hanger embodiment of the invention that may be used as an over-the-door wreath holder 402 with an insert area 404. The hanger comprises an elongated strip of material 406 having a first end 408 with a hook structure and a second or lower end that curves upwardly to hold a wreath 412. The material associated with the first or upper end if preferably bent back twice as shown to create a section “W” having a width in the range of 1 to 3 inches to fit over a door. The thickness of the material “T” is preferably thin enough to remain on the door when the door is closed. As such, T is about 1/16″, more or less, While plastic may be used for member 406, bent metal is preferred, and steel or other magnetic metal is more preferred to facilitate a magnetic connection to insert holder body 414 which, in preferred embodiments, is interchangeable.

Inset area 404 may be a cavity with or without a cover, as shown in FIGS. 1A, B, or region 404 may be adapted to receive a decorative needlepoint, textile, fabric or other material sewn, stitched or otherwise attached. In addition, there may be an added feature of a hinged glass door to cover a fabric element on some wreath holders for photos, fabric or other substrates. Although holder 414 is depicted as round/oval, any other regular or irregular shape may be used, including without limitation, regular and irregular polygons; ornate and decorative shapes such as fish, whales, dog/pet silhouettes; and holiday shapes such as Christmas trees, Easter eggs, Star of David, and so forth.

The insert older may be attached to the elongated member 406 in any appropriate manner, including mechanical and magnetic connections. FIG. 4B illustrates a mechanical connection wherein a slot 420 on the backside of holder 414 receives the end 422 of the member 406. FIG. 4C illustrates different possible connections, including a magnet 430 on the back of holder 414 that engages with an oppositely polarized magnet 432 on the end of member 406. Note that if member 406 or holder 414 is steel or magnetic, only one magnet may be required. Alternatively, items 430, 432 may represent hook-and-loop fasteners. Thus, given the ability to exchange the insert holder 414 as well as the insert itself, the embodiments of FIG. 4 allows at least two degrees of configurability.

FIG. 5 illustrates a soap dish with oval, square, round, heart, fish silhouette, dog silhouette, cat silhouette, and/or bottom insert regions 502, 504, 506 to be interchanged with decorative element(s).

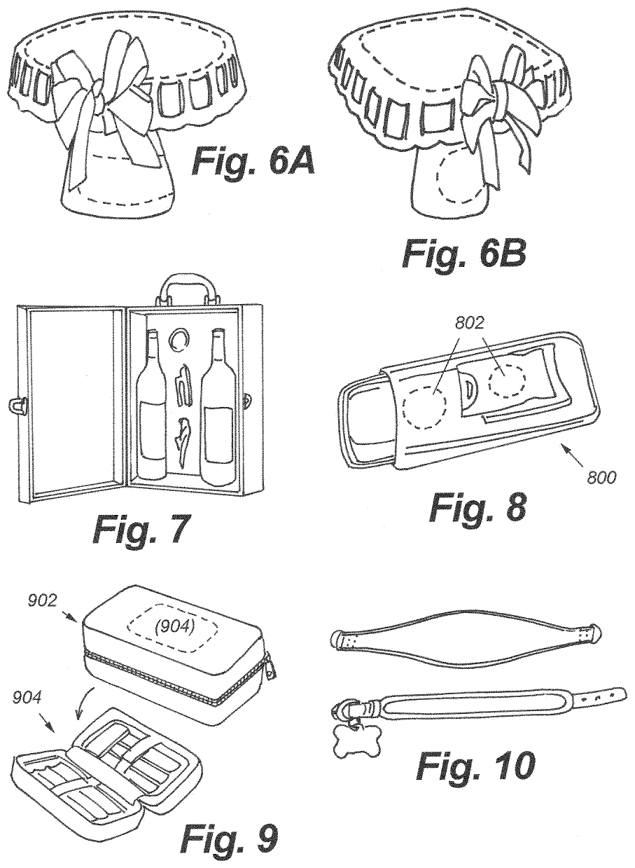

FIG. 6A shows a round cake platter stand, and FIG. 6B shows a square platter. In each case, the decorative element region is on the top of the stand but encased and not exposed. In these embodiments, decorative interchangeable elements include a hinged or snap-off cover that is transparent and removable. The cake stand may also have a glass section that just sits directly on top to separate the decorative feature, or a clear acrylic snap on feature to separate it.

FIG. 7 is a drawing of a wine-carrying case that may or may not include a cover. In this instance, the decorative element may be sewn on any outer surface of the case. FIG. 8 shows a decorative insert 800 on top of a cigar case holder 802. However, the invention is not limited in terms of the type or shape of the case, which can include personal hand carried cigar covers and cases, travel cigar leather case holders, portable humidor cases, and so forth, with decorative elements on any available surfaces;

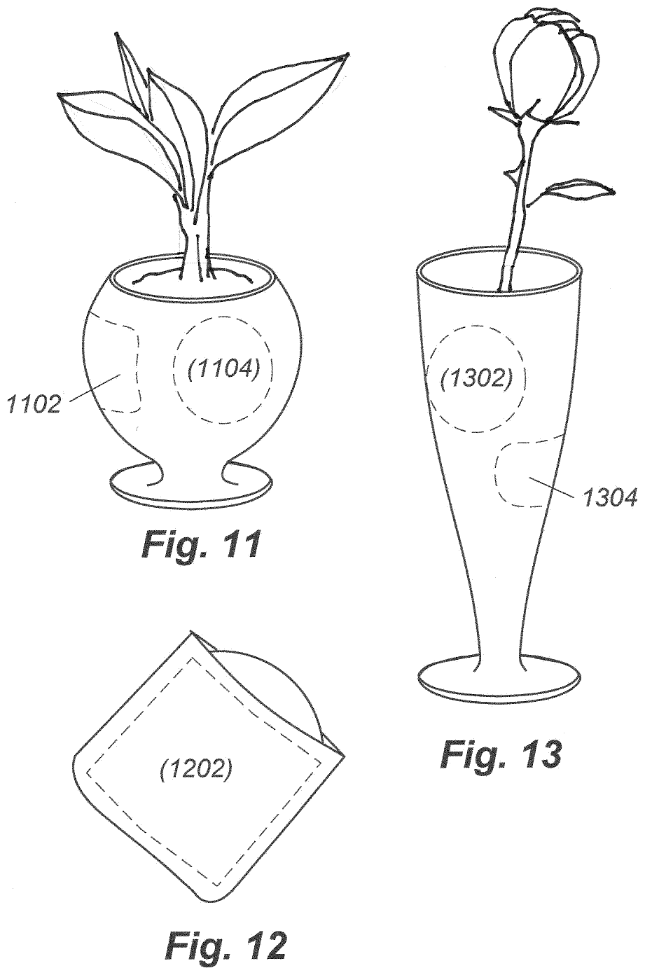

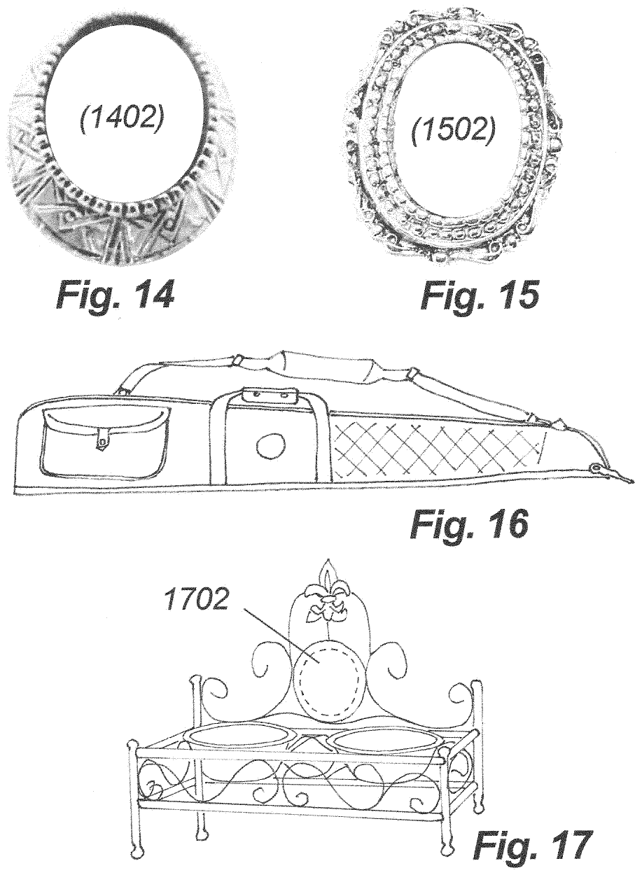

FIG. 9 is a small desk humidor box 902 with a space 904 for a decorative element on a top surface thereof. FIG. 10 is a Martingale and Zweig art canvas collar for needlepoint inserted and sewn in middle leather on edges. FIG. 11 illustrates a ceramic photo planter round pot for plants with regions(s) 1102, 1104 to receive interchangeable elements. FIG. 12 shows a disc sleeve with a region 1202 to receive an interchangeable element. FIG. 13 depicts a photo vase with openings 1302, 1304, etc., for interchangeable element(s). FIGS. 14, 15 are scarf clip holders with front openings 1402, 1502 that my assume any of the shapes disclosed herein. FIG. 16 is a leather rifle/shotgun case with outside pocket of needlepoint sewn on outside, and FIG. 17 is a wrought iron double bowl holder. The small central opening 1702 in this case may be configured to hold needlepoint or other interchangeable decorative elements.

1. A reconfigurable article, comprising:
a shell component, including:
an upper rim;
an outer wall extending downwardly and outwardly from the upper rim to a lower rim, and wherein at least a portion of the outer wall is transparent or translucent;
an inner wall extending downwardly and inwardly to a bottom wall, such that the inner wall and bottom wall form a sealed bowl structure;
wherein the outer and inner wall are spaced apart, forming a cavity between the outer and inner walls that is accessible from the bottom of the shell component;
a flexible insert having first and second opposing sides, and wherein at least one of the sides includes graphical or textual visual indicia;
wherein the flexible insert is configured for insertion into the bottom of the cavity so as to occupy the cavity of the shell enabling a user to visualize the graphical or textual indicia through the transparent or translucent outer wall of the shell; and
a retainer component configured to maintain the flexible insert in the cavity of the shell.

2. The reconfigurable article of claim 1, wherein the upper rim of the shell is circular with a diameter.

3. The reconfigurable article of claim 2, wherein the lower rim of the shell is circular with a diameter larger than that of the upper rim.

4. The reconfigurable article of claim 2, wherein the diameter of the upper rim is in the range of 4 to 8 inches.

5. The reconfigurable article of claim 1, wherein:
the flexible insert comprises a thin strip of flexible material having a concave upper edge and a convex lower edge defining a width; and
two ends defining a length.

6. The reconfigurable article of claim 5, wherein:
the outer wall of the shell defines a height; and
the width of the flexible insert corresponds to the height of the outer wall of the shell.

7. The reconfigurable article of claim 1, wherein the retainer component is configured for insertion into the cavity of the shell such that the flexible insert is disposed between the retainer component and the outer wall of the shell.

8. The reconfigurable article of claim 7, wherein:
the retainer component has an upper edge and a lower edge; and
the lower edge of the retainer component temporarily and releasably engages with the shell proximate to the lower rim thereof

9. The reconfigurable article of claim 8, wherein:
the outer wall of the shell includes an inner annular groove proximate to the lower rim of the shell; and
the lower edge of the retainer component includes one or more protrusions or tabs that engage with the inner annular groove of the outer wall of the shell.

10. The reconfigurable article of claim 7, wherein the retainer component forms a frusto-conical shape.

11. The reconfigurable article of claim 1, wherein the bottom wall of the sealed bowl structure includes a region adapted to receive a second insert including graphical or textual visual indicia;

12. The reconfigurable article of claim 10, wherein:
the bottom wall of the sealed bowl structure is transparent or translucent;
the region adapted to receive the second insert is a cavity accessible from the bottom of the shell component; and
a cover for closing off the cavity with the second insert retained therein such that the graphical or textual indicia of the second insert is visible through the bottom wall of the sealed bowl structure.

13. A reconfigurable article, comprising:
an elongated member having first and second ends;
wherein the first end of the elongated member is bent into a hanger shape;
a body having a front surface, a back surface and a peripheral edge defining a geometric shape;
wherein the front surface of the body includes a region configured to receive an insert having first and second opposing sides, and wherein at least one of the sides includes graphical or textual visual indicia; and
wherein the back surface of the body includes a device that facilitates temporarily and releasable attachment to the second end of the elongated member.

14. The reconfigurable article of claim 13, wherein the region configured to receive the insert includes a cavity and a cover that mounts over the cavity to protect the insert.

15. The reconfigurable article of claim 13, wherein the insert is sewn, stitched or bonded to the region without being covered.

16. The reconfigurable article of claim 13, wherein:
the first end of the elongated member is bent to conform to the upper edge of a door such that the elongated member hangs downwardly;
the second end of the elongated member is bent upwardly to hold a toroidally shaped wreath; and
the body temporarily and releasably attaches to the second end of the elongated member such that the graphical or textual visual indicia faces outwardly from the door.

17. The reconfigurable article of claim 16, wherein body temporarily and releasably attaches to the second end of the elongated member by way of a magnetic or mechanical attachment.

18. A flexible insert configured for insertion into a cavity in a reconfigurable article, comprising:
a thin flexible elongated substrate having front and back outer surfaces, a concave upper edge and a convex lower edge defining a width, and two ends defining a length;
wherein one of the front and back outer surfaces is adapted to receive graphical or textual visual indicia.

19. The flexible insert of claim 18, wherein the concave upper edge and convex lower edge are circular curves with radii measured from a common center point such that the width is consistent along the thin flexible elongated substrate.

20. The flexible insert of claim 18, wherein the thin flexible elongated substrate is a mesh material adapted to receive needlepoint or crocheted graphical or textual visual indicia.
